(19) United States
(12) Patent Application Publication
(10) Pub. No.: US 2008/0201330 A1
(43) Pub. Date: Aug. 21, 2008

(54) SOFTWARE REPOSITORIES

(75) Inventor: Anthony Christopher Bloesch, Vashon, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/676,170

(22) Filed: Feb. 16, 2007

(51) Int. Cl. G06F 17/30

(52) U.S. Cl. 707/8

(57) ABSTRACT

The present invention extends to methods, systems, computer program products, and data structures for software repositories. Embodiments of the invention permit a user to group software related items from a software repository in repository container versions such that software related items can be accessed and processed together. A user has wide discretion on how software related items are grouped in repository container versions to facilitate efficient access and processing in varied computing environments. In some embodiments, software related items are grouped in the same repository container version based on component version such that all the software related items for a specified version of an application, framework, or service can be accessed and processed together. Accordingly, operations (e.g., replication or partitioning) can be performed on all the software related items in the repository container version to effectuate performing the operation on the specified version of the application, framework, or service.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing components.

Software code is typically written by one or more software developers using some type of integrated development environment (IDE). In many cases, developers are given a set of design instructions, and, using a programming language, draft software code that will implement the functions described in the design specifications. Depending on the nature and scope of the design specifications (or any subsequent modifications thereto), the software program can be both large and complex.

Enterprise software programs, for example, may involve many hundreds or thousands of software files, each file designed to interact with other files within the program and externally with other software programs and/or operating systems. Often, supplemental programs or databases, such as, for example, software repositories, are used to organize, search and maintain the metadata which describes the program and its files. Program metadata consists of information such as the structure of program components, behavior of those components, and other characteristics useful for organization and control. File metadata consists of information such as the date the file was last modified, the size of the file, the file's relation to other files within the software program, and other characteristics useful for organization and control.

One approach for organizing a software repository includes storing a software program's objects and their corresponding metadata together using an entity-property-value approach (also called the universal schema approach). Using an entity-property-value approach most data is stored in a table of property ID/value pairs. Thus, a software repository can be organized such that objects are listed alphabetically with the metadata alongside, each portion of metadata corresponding to the appropriate object. For example, a software repository can list a software object and a name and corresponding value for the each property of the software object. Related objects can be, for example, shown as a list of related objects headed by the kind of relationship (e.g., objects related to another object by an automatic generation process).

Using an entity-property-value approach data is stored in a highly uniform way making it relatively easy to build generic repository APIs and browsers. However, due to the (typically finer) granularity with which software objects are stored (i.e., per object), querying an entity-property-value based software repository can be complex and inefficient. Many objects can include additional relationships to one another (e.g., based on user-preference, code version, access patterns, replication, etc.) causing them to be frequently accessed together. However, these additional relationships are not easily represented using entity-property-value approach. Thus, although these objects are related in additional ways, they typically cannot be easily accessed as a group. Accordingly, queries may be required to access objects individually and then subsequently group them together for performing further operations.

Another approach for organizing a software repository includes storing a metadata in XML columns or some other post-relational structure. As opposed to name/value pairs, post-relational structures permit complex data values to be stored in a field. Because some database servers have efficient ways to store XML, an XML column or other post-relational approach can be efficient for hierarchical data (e.g., type definitions of an object oriented software program). Using a post-relational approach, hierarchical data can be flexibly grouped.

However, due to the (typically coarser) granularity with which software objects are stored (i.e., in a hierarchical tree), querying a post-relational based software repository can be also be complex and inefficient. For example, objects can be related in ways that don't conform well to a hierarchical structure (e.g., based on user-preference, code version, access patterns, replication, etc.) and thus related objects can span different hierarchical trees. Accordingly, queries may be required to access different sub-trees from different post-relational structures and then merge the results together for performing further operations.

Further, most database tools are designed for use with databases based on conventional schemas (as opposed to universal schema or post-relational) making their use with entity-property-value and post-relational based software repositories more difficult. As such, not only are these queries typically more complex, a developer must often resort to developing queries without the automated development capabilities included in these database tools. Accordingly, at the very least, creating software repository queries can consume significant developer resources (that would otherwise be used to develop code). In many cases, creating software repository queries will be beyond the technical expertise of a developer (that while trained in code development may lack expert knowledge in database queries).

### BRIEF SUMMARY

The present invention extends to methods, systems, computer program products, and data structures for software repositories. A computer system includes a software repository used to store software related items for a plurality of software units. The software repository includes a container version mapping for each deployable software unit. Each container version mapping includes a software unit field storing a software unit value that identifies the software unit, from among the plurality of software units. Each container version mapping also includes a container version ID field storing a container version identifier value. The container version ID is used within the software repository to identify a repository container version mapped to the software unit identified by the software unit value stored in the software unit field.

The software repository also includes a plurality of tables storing software related items by item type. Each table includes a plurality of rows of software related items corresponding to a specified item type. Each row includes a software related item data field storing software related data. Each row also includes a container version ID field storing a container version ID value from a container version mapping for a deployable software unit. The container version ID value designates that the software related data stored in the software related item data field corresponds to the repository container version that is mapped to the deployable software unit.

In some embodiments, software related items are stored in a software repository. A computer system accesses a software related item that is to be stored in the software repository. The computer system identifies a specified software unit, from among the plurality of software units, associated with the software related item. The computer system refers to a container version mapping to locate a repository container version that corresponds to the specified software unit.

The computer system retrieves a container version ID for the repository container version from the container version mapping. The computer system stores the software related item along with the container version ID in the software repository to indicate that the software related item is associated with the software unit. Accordingly, if the software repository is queried for software related items associated with the software unit, the software related item, as well as any other software related items stored along with the container version ID, are returned in response to the query.

In other embodiments, an operation is performed for a specified software unit. A computer system receives a command to perform a specified operation on a software unit. The computer system refers to a container version mapping to locate a repository container version that corresponds to the specified software unit. The computer system retrieves a container version ID for the repository container from the container version mapping.

The computer system queries the software repository for any software related items that are stored along with container version ID for the repository container version. The computer system receives references to a plurality of software related items from the software repository in response the query. The computer system performs the specified operation on each software related item in the plurality of referenced software related items to effectuate performing the specified operation on the software unit.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates software repositories.

FIG. 2 illustrates an example relationship between repository containers and repository items.

FIG. 3 illustrates a flowchart of a method for storing a software related item in a software repository in a manner that indicates the software related item is associated with a specified software unit.

FIG. 4 illustrates a flowchart of a method for performing an operation for a specified software unit.

### DETAILED DESCRIPTION

The present invention extends to methods, systems, computer program products, and data structures for software repositories. A computer system includes a software repository used to store software related items for a plurality of software units. The software repository includes a container version mapping for each deployable software unit. Each container version mapping includes a software unit field storing a software unit value that identifies the software unit, from among the plurality of software units. Each container version mapping also includes a container version ID field storing a container version identifier value. The container version ID is used within the software repository to identify a repository container version mapped to the software unit identified by the software unit value stored in the software unit field.

The software repository also includes a plurality of tables storing software related items by item type. Each table includes a plurality of rows of software related items corresponding to a specified item type. Each row includes a software related item data field storing software related data. Each row also includes a container version ID field storing a container version ID value from a container version mapping for a deployable software unit. The container version ID value designates that the software related data stored in the software related item data field corresponds to the repository container version that is mapped to the deployable software unit.

In some embodiments, software related items are stored in a software repository. A computer system accesses a software related item that is to be stored in the software repository. The computer system identifies a specified software unit, from among the plurality of software units, associated with the software related item. The computer system refers to a container version mapping to locate a repository container version that corresponds to the specified software unit.

The computer system retrieves a container version ID for the repository container version from the container version mapping. The computer system stores the software related item along with the container version ID in the software repository to indicate that the software related item is associated with the software unit. Accordingly, if the software repository is queried for software related items associated with the software unit, the software related item, as well as any other software related items stored along with the container version ID, are returned in response to the query.

In other embodiments, an operation is performed for a specified software unit. A computer system receives a command to perform a specified operation on a software unit. The computer system refers to a container version mapping to locate a repository container version that corresponds to the specified software unit. The computer system retrieves a container version ID for the repository container from the container version mapping.

The computer system queries the software repository for any software related items that are stored along with container version ID for the repository container version. The computer system receives references to a plurality of software related items from the software repository in response the query. The computer system performs the specified operation on each software related item in the plurality of referenced software related items to effectuate performing the specified operation on the software unit.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise physical (or recordable type) computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or other communications connection (either hardwired, wireless, or a combination of hardwired or wireless) to a computer, the computer properly views the connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

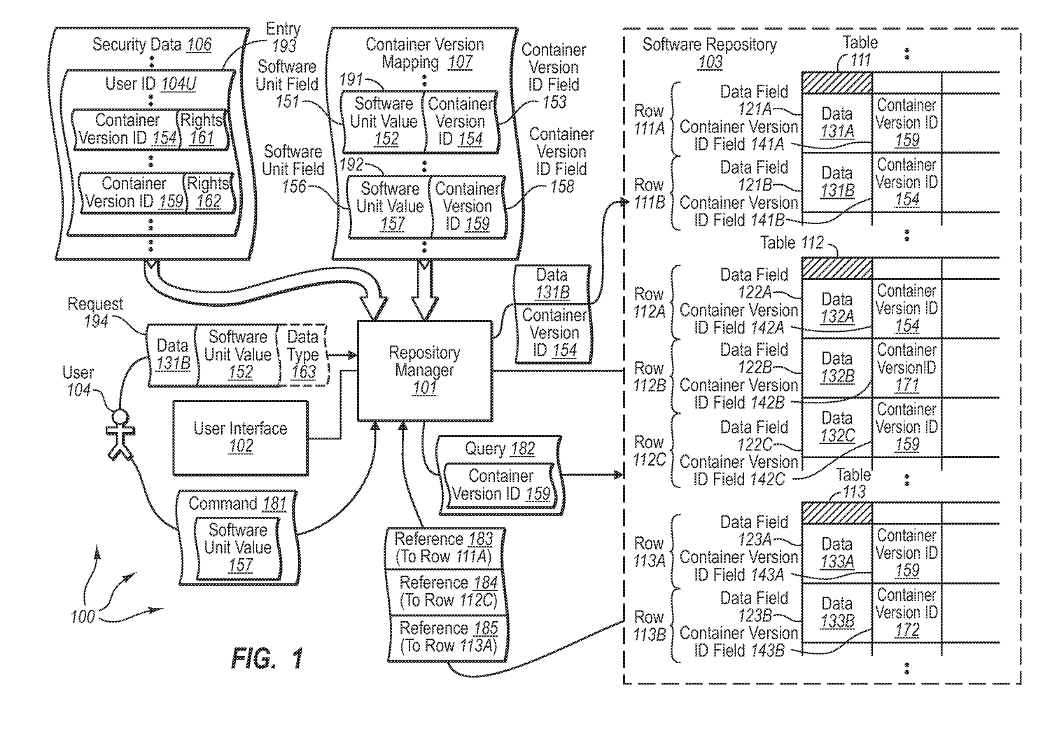

FIG. 1 illustrates an example computer architecture 100 that facilitates software repositories. As depicted computer architecture 100 includes repository manager 101, user-interface 102, software repository 103, security data 106, and container version mapping 107. Repository manager 101, user-interface 102, software repository 103, security data 106, and container version mapping 107 can be connected to a network, which can be virtually any network or combination thereof, such as, for example, a Local Area Network (“LAN”), a Wide Area Network (“WAN”), and even the Internet. Thus, repository manager 101, user-interface 102, and software repository 103, as well as any other connected components and computer systems, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network. Accordingly, data stored software repository 103, security data 106, and container version mapping 107 can be accessed and manipulated through the exchange of network message related data over the network.

User-interface 102 is configured to receive user entered input requests and commands for accessing and/or manipulating data (e.g., software related items) stored in software repository 103. User-interface 102 is also configured to receive user entered input requests and commands for accessing and/or manipulating the data structures (e.g., tables) used to store data in software repository 103. User-interface 102 is also configured to present results corresponding to user entered requests and commands back to a user.

Generally, software repository 103 is configured to store software related items, such as, for example, metadata, for a plurality of software units. Metadata can describe the structure of software components, the behavior of software components, and other characteristics useful for organization and control of software components. A software unit can be an application (e.g., a word processor or electronic mail client), a framework (e.g., a development framework), a service (e.g., a web service or other mechanism for sharing business logic), or some other aggregation of interoperating software components that perform one or more functions.

A software unit can be user-defined based on a user's desire to group specified software related items together and/or separate specified software related items from one another. For example, a user (administrator or operations staff) can divide software repository 103 into a plurality of different software units based on security criteria, data access patterns, replication criteria, scalability criteria, versioning criteria, subjective criteria the administrator believes to be relevant, or some combination thereof, with respect to software related item data stored in software repository 103.

Generally, container version mapping 107 is configured to map a software unit to a container version ID. The container version ID corresponds to a repository container version that logically stores software related item data that has been grouped into the software unit. Repository container versions can be configured in a variety of different ways to group software related item data together for a software unit.

In some embodiments, for each software unit, container version mapping 107 can include a software unit field storing a software unit value that identifies a software unit. For example, software unit indicator 191 includes software unit field 151 storing software unit value 152 and corresponds to a software unit. A software unit value can be a friendly name for the software unit, such as, for example, “Development Framework A, Version 1.7”.

In these embodiments, for each software unit, container version mapping 107 can also include a container version ID field storing a container version identifier value. The container version identifier value can be used within software repository 103 to identify a repository container version mapped to a software unit identified by the software unit value stored in the software unit field. For example, software unit indicator 191 includes container version ID field 153 storing container version ID 154. Container version ID 154 can be used within software repository 103 to identify a repository container version mapped to software unit indicator 191.

In some embodiments, software related items are stored within software repository 103 in tables by item type. For example, there can be one table storing software related items for classes (e.g., table 111), another table storing software related items for methods (e.g., table 112), yet another table storing software related items for interfaces (e.g., table 113), etc. Tables can include a plurality of rows. For example, table 111 includes at least rows 111A and 111B, tables 112 includes at least rows 112A, 112B, and 112C, and table 113 includes at least rows 113A and 113B.

In these embodiments, each row includes a software related item data field (e.g., in a software related item data column) storing software related data. For example, rows 111A and 111B include data fields 121A and 121B storing software data related data 131A and 131B respectively. Rows 112A, 112B, and 112C include data fields 122A, 122B, and 122C storing software related data 132A, 132B, and 132C respectively. Rows 113A and 113B include data fields 123A and 123B storing software related data 133A and 133B respectively.

Also in these embodiments, each row includes a container version ID field (e.g., in a container version ID column) storing a container version ID value from a container version mapping for a software unit. The container version ID value designates that the software related data stored in the software related item data field corresponds to a repository container version that is mapped to the software unit. For example, rows 111A and 111B includes container version ID fields 141A and 141B storing container IDs 159 and 154 respectively. Rows 112A, 112B, and 112C include container version ID fields 142A, 142B, and 142C storing version container IDs 154, 171, and 159 respectively. Rows 113A and 113B include container version ID fields 143A and 143B storing container version IDs 159 and 172 respectively.

Container version ID fields that store container version ID 154 designate that software related item data in the same row corresponds to a repository container version that is mapped to software unit indicator 191. For example, container version ID value 154 stored in container version ID filed 142A designates that data 142A corresponds to a repository container version mapped to software unit indicator 191. Container version ID fields that store version container ID 159 designate that software related item data in the same row corresponds to a repository container version that is mapped to software unit indicator 192. For example, container version ID value 159 stored in container version ID filed 141A designates that data 131A corresponds to a repository container version mapped to software unit indicator 192. Other container version IDs, such as, for example, container version IDs 171 and 172, can designate that software related item data corresponds to repository container versions mapped to other d software units not expressly depicted in container version mapping 107.

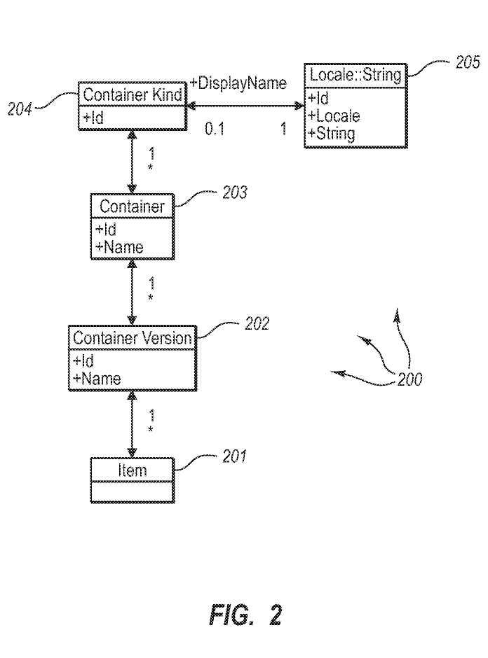

The relationship between repository containers and repository items can be established and maintained in a variety of different ways. Referring now to FIG. 2, FIG. 2 illustrates an example relationship 200 between repository containers and repository items. As depicted, Container Kind 204 defines a specified kind of container, such as, for example, a container for software related items corresponding to an application, a framework, or a service. Each kind of container can be given an identifier and a string-based display name as defined by 205.

Container 203 is defined as of the type Container Kind 204 and includes and ID and name. For example, container 203 can be of the type application container kind to store software related items for a set of software components comprising a Word Processing Application.

Containers can also be versioned to account for evolving systems. Thus, container version 202 is defined as of the type of container 203 for a specified version of software components. For example, container version 202 can define a first instance of the Word Processing Application container corresponding to software components comprising Word Processing Application, Version 1.0 and a second separate instance of the Word Processing Application container corresponding software components comprising Word Processing Application, Version 2.0. However, the relationship between a container's versions is not prescribed and users can structure container versions in arbitrary ways. For example, container versions can have a linear structure or a tree structure.

Item 201 defines that an item can be stored in a container version. In some embodiments, each software related item is stored in exactly one container version. Accordingly, in these embodiments, each software related item in software repository 103 corresponds to exactly one container version ID, wherein the container version ID is used to identify a repository container version of a container that is in a family of containers defined by a container kind (204), a set of software components (203), and version of those software components (202).

Container version versions form a natural unit of security in a software repository. Since container versions are a natural unit of aggregation in the software repository and all repository items belong to exactly one container version, securing repository items at the level of container versions results in a relatively simple security model. Through the security model, repository administrators are able to grant individual users read or update permission on individual container versions. Because repository users can choose their container models to match the desired security granularity, the security model has inherent flexibility.

Referring back to FIG. 1, generally, security data 106 is configured to reflect users' rights to repository containers version. Security data 106 includes a list of entries, such as, for example, entry 193, that identify a user ID and the rights the user ID has to software related item data designated as corresponding to a specified repository container version. Each user ID can correspond to a set of credentials for a specified user. For example, user ID 104U can correspond to credentials for user 104. Thus, any user that authenticates with credentials for user ID 104U is given rights that have been granted to user 104.

Each entry can include a list of container version IDs and the rights granted (or denied) to software related item data for the repository container version corresponding to the container version ID. For example, entry 193 indicates that user ID 104U has been granted (or denied) rights 161 to the repository container version corresponding to container version ID 154. Similarly, entry 193 indicates that user ID 104U ahs been granted (or denied) rights 162 to the repository container version corresponding to container version ID 159. Granted or denied rights can include rights to create, read, write, delete, or enumerate software related item data in a software repository version. Granted or denied rights can also include rights to create, read, write, delete, or enumerate data structures (e.g., tables) used to store software related item data in a software repository.

Generally, repository manager 101 is configured to manage access to software related item data stored in software repository 103 and to manage access to data structures (e.g., tables) used to store software related item data in software repository 103. Repository manager 101 can include the functionality to implement any specified operations which a user has been granted rights to perform.

From time to time, repository manager can receive user requests related to data in a software unit. Repository manager 101 can refer to container version mapping 107 to identify the container version ID corresponding to the software unit. In accordance with the security model, repository manager 101 can then access an entry from security data 106 that corresponds to the user's user ID. Repository manager 101 can use the entry to determine if the user ID has rights to perform the user request with the repository container version corresponding to the user ID.

For example, repository manager 101 can receive a request from user 104 requesting performance of an operation in the repository container version corresponding to container version ID 154. In response, repository manager 101 can access entry 193. Repository manager 101 can refer to rights 161 to determine if user 104 is permitted to perform the requested operation.

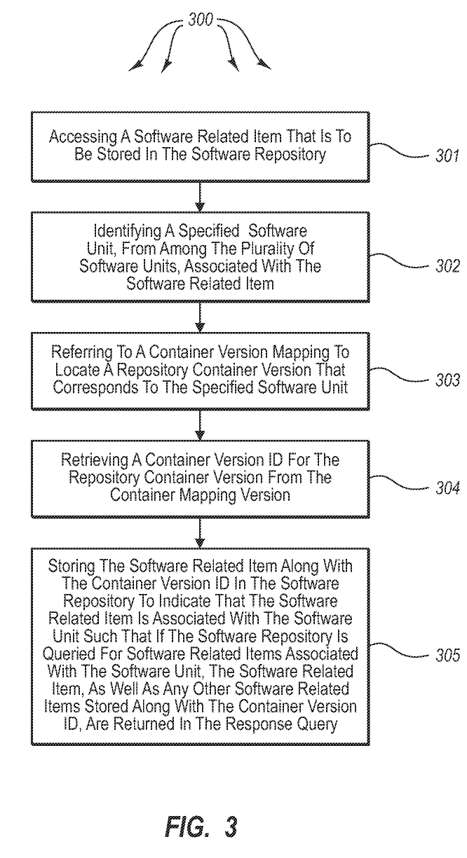

FIG. 3 illustrates a flowchart of a method 300 for storing a software related item in a software repository in a manner that indicates the software related item is associated with a deployable software unit. Method 300 will be described with respect to the components and data in computer architecture 100.

Method 300 includes an act of accessing a software related item that is to be stored in the software repository (act 301). For example, a user can enter input data for formulating request 194 at user interface 102. User interface 102 can formulate request 194 from the input data and send request 194 to repository manager 101. Repository manager 101 can receive request 194 from user interface 102. Request 194 includes data 131B (e.g., a software related item), software unit value 152, and can optionally include data type 163. Data type 163 can indicate the type of software component, such as, for example, class, method, interface, etc. that data 131B relates to.

Method 300 includes an act of identifying a specified software unit, from among the plurality of software units, associated with the software related item (act 302). For example, repository manager 101 can identify software unit indicator 191 from software unit value 152.

Method 300 includes an act of referring to a container version mapping to locate a repository container version that corresponds to the specified deployable software unit (act 303). For example, based on software unit value 152, repository manager 101 can refer to container version mapping 107 to locate a repository container version that corresponds to software unit indicator 191. Method 300 includes an act of retrieving a container version ID for the repository container version from the container version mapping (act 304). For example, repository manager 101 can retrieve container version ID 154 from container version mapping 107.

When appropriate, repository manager 101 can refer to security data 106 prior to implementing act 305. Repository manager 101 can access entry 193 to determine that user 104 has sufficient rights to store software related item data in the repository container version identified by container version ID 154.

Method 300 includes an act of storing the software related item along with the container version ID in the software repository to indicate that the software related item is associated with the software unit (act 305). Accordingly, if the software repository is queried for software related items associated with the software unit, the software related item, as well as any other software related items stored along with the container version ID, are returned in response to the query. For example, repository manager 101 can store data 131B in data field 121B and store container version ID 154 in container ID field 141 to designate that data 131 is associated with software unit indicator 191. Repository manager 101 can store data 131B and container version ID 154 in table 111 based on data type 163 corresponding to table 111. When appropriate, for example, when request 194 does not include data type 163, repository manager 101 can determine the data type of data 131B based on the contents of data 131B. Thus, when software repository 103 is queried for software related items associated with software unit indicator 191, data 131, as well as other data stored along with container version ID 154, are returned in response to the query.

Repository manager 101 can return any results for request 194 to user interface 102. User interface 102 can display the results to user 104.

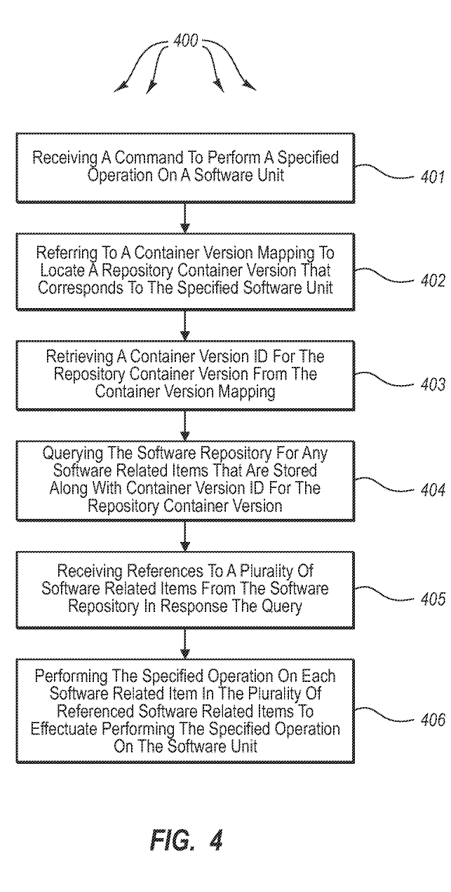

FIG. 4 illustrates a flowchart of a method 400 for performing an operation for a specified software unit. Method 400 will be described with respect to the components and data in computer architecture 100.

Method 400 includes an act of receiving a command to perform a specified operation on a software unit (act 401). For example, a user can enter input data for formulating command 181 at user interface 102. User interface 102 can formulate command 181 to include software unit value 157 from the input data and send command 181 to repository manager 101. Repository manager 101 can receive command 181 from user interface 102. Command 181 can be a command to replicate, partition, etc., the software unit. For example, it may be that the software unit is frequently accessed and a user desires to partition the software unit onto a disk drive having reduced access times.

Method 400 includes an act of referring to a container version mapping to locate a repository container version that corresponds to the software unit (act 402). For example, based on software unit value 157, repository manager 101 can refer to container version mapping 107 to locate a repository container version that corresponds to software unit indicator 192. Method 400 includes an act of retrieving a container version ID for the repository version container from the container version mapping (act 403). For example, repository manager 101 can retrieve container version ID 157 from container version mapping 107.

When appropriate, repository manager 101 can refer to security data 106 prior to implementing act 304. Repository manager 101 can access entry 193 to determine that user 104 has sufficient rights to perform the operation indicated in command 101 in the repository container version identified by container version ID 154. A user may be required to have a combination of rights to perform an operation. For example, to replicate software related item data in a repository, a user may be required to have both read and write access to the repository container version.

Method 400 includes an act of querying the software repository for any software related items that are stored along with container version ID for the repository container version (act 404). For example, repository manager 101 can issue query 182 to software repository 103 for any software related item data stored along with container version ID 159. Method 400 includes an act of receiving references to a plurality of software related items from the software repository in response the query (act 405). For example, repository manager 101 can receive references 183 (to row 111A), 184 (to row 112C), and 185 (to row 113A) from software repository 103 in response to query 182.

Method 400 includes an act of performing the specified operation on each software related item in the plurality of referenced software related items to effectuate performing the specified operation on the software unit (act 406). For example, repository manager 101 can perform the specified operation on data 131A, 132C, and 133A (on all the data in rows 111A, 112C, and 113A) to effectuate performing the specified operation on the software unit corresponding to software unit indicator 191. Thus, repository manager 101 can replicate or partition all the software related items designated as being in a repository container version to effectuate replicating or partitioning the repository container version.

Repository manager 101 can return any results for command 181 to user interface 102. User interface 102 can display the results to user 104.

In some embodiments, there are also relationships between items across container version boundaries. Relationships across container version boundaries can be computed based on domain specific resolution rules (e.g., CLR linking rules). Thus, domains can reuse domain specific mechanisms used to resolve references across versions.

Soft links (late binding links) provide a name based mechanism for referencing repository items that are resolved, by providers, at traversal time and may not refer to any actual repository item. Soft links may refer to repository items in other repositories either by explicitly identifying the repository or by giving a list of repositories. Domain implementers provide routines that given a soft link return the corresponding repository item. Source models are free to store soft links in an arbitrary way as long as they can generate a soft link to pass to the corresponding routine. Soft links can be stored implicitly and constructed at query time.

Since databases can store typed XML in a compact binary format, soft links can be stored efficiently and domains can also construct them from other data and a suitable context. Server names or addresses can be used in environments where some software repository items are kept locally and other software repository items are infrequently accessed from other repositories. For example, in a geo-scaled scenario a individual server in, Japan can map to the Corp. role for departmental repositories in East Asia and a server in the United States would can map to the Corp. role for departmental repositories in the Americas.

Domains can supply table valued functions following the naming scheme [Domain].[ResolveItemTypeLink] that resolve soft links to repository items. Given a soft link, a soft link resolution function will return the corresponding item (or if no item was found then no row). In some cases a resolution procedure may allow ambiguous names and return multiple rows.

The helper function [Item].[LinkContainerVersion] takes a soft link and returns the ID of the container version the soft link refers to. The helper function [Item].[LinkServerRoles] takes a soft link and returns an ordered list of linked servers to query. The helper function [Item].[CreateLink] takes soft link version information, the container version and the path and returns a soft link of the appropriate version. Factoring the link API this way improves performance because each soft link resolution function will have a known result type, less dynamic code is involved and network traffic is reduced where the target repository is known ahead of time

Accordingly, embodiments of the present invention permit a user to group software related items from a software repository such that the software related items can be accessed and processed together. A user has wide discretion on how software related items are to be grouped such that repository containers version are configured for efficient use in a particular environment. In some embodiments, software related items are grouped in the same repository container version based on component versions such that all the software related items for a specified version of an application, framework, or service can be accessed and processed together. Accordingly, an operation can be performed on all the software related items in the repository container version to effectuate performing the operation on the specified version of the application, framework, or service.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system, the computer system including a software repository used to store software related items for a plurality of software units, each software related item being associated with a software unit from among the plurality of software units, a method for storing a software related item in the software repository in a manner that indicates the software related item is associated with a specified software unit, the method comprising:
an act of accessing a software related item that is to be stored in the software repository;
an act of identifying a specified software unit, from among the plurality of software units, associated with the software related item;
an act of referring to a container version mapping to locate a repository container version that corresponds to the specified software unit;
an act of retrieving a container version ID for the repository container from version the container version mapping; and
an act of storing the software related item along with the container version ID in the software repository to indicate that the software related item is associated with the software unit such that if the software repository is queried for software related items associated with the software unit, the software related item, as well as any other software related items stored along with the container version ID, are returned in response to the query.

2. The method as recited in claim 1, wherein the act of accessing a software related item that is to be stored in the software repository comprises an act of accessing metadata describing one or more of the structure of software components, the behavior of software components, and other characteristics useful for organization and control of software components.

3. The method as recited in claim 1, wherein the act of accessing a software related item that is to be stored in the software repository comprises an act of accessing metadata related to one of a programming class, a programming method, and a programming interface.

4. The method as recited in claim 1, wherein the act of accessing a software related item that is to be stored in the software repository comprises an act of accessing software related item that is to be stored in a software repository that stores software related items for different types of software components in different tables

5. The method as recited in claim 1, wherein the act of accessing a software related item that is to be stored in the software repository comprises an act of receiving a user entered request to store the software related item.

6. The method as recited in claim 5, further comprising:
an act of referring to container version security data to determine that the user has sufficient rights to store software related items in the repository container version.

7. The method as recited in claim 1, wherein the act of identifying a specified software unit comprises an act of identifying a specified version of an application, a framework, or a service.

8. The method as recited in claim 1, wherein the act of storing the software related item along with the container version ID in the software repository comprises an act of storing the software related item along with the container version ID in the same row of a database table.

9. At a computer system, the computer system including a software repository used to store software related items for a plurality of software units, each software related item being associated with a software unit from among the plurality of software units, a method for performing an operation for a specified software unit, the method comprising:
an act of receiving a command to perform a specified operation on a software unit;
an act of referring to a container version mapping to locate a repository container version that corresponds to the software unit;
an act of retrieving a container version ID for the repository container version from the container version mapping;
an act of querying the software repository for any software related items that are stored along with container version ID for the repository container;
an act of receiving references to a plurality of software related items from the software repository in response the query; and
an act of performing the specified operation on each software related item in the plurality of referenced software related items to effectuate performing the specified operation on the software unit.

10. The method as recited in claim 9, wherein the act of receiving a command to perform a specified operation on a software unit comprises an act of receiving a command to replicate or partition a software unit.

11. The method as recited in claim 9, wherein the an act of receiving a command to perform a specified operation on a software unit comprises an act of receiving a user entered command to a specified operation on a software unit.

12. The method as recited in claim 11, further comprising:
an act of referring to container version security data to determine that the user has sufficient rights to perform the specified operation in the repository container version.

13. The method as recited in claim 9, wherein the act of querying the software repository for any software related items that are stored along with container version ID for the repository container version comprises an act of querying a plurality of different tables in the software repository for software related items designated by the container version ID as corresponding to the repository container version.

14. The method as recited in claim 9, wherein an act of receiving references to a plurality of software related items from the software repository in response the query comprises an act of receiving references to rows of a plurality of different database tables within the software repository.

15. The method as recited in claim 9, wherein an act of performing the specified operation on each software related item in the plurality of referenced software related items comprises an act of replicating each software related item in the plurality of referenced software related items to effectuate replicating the software unit.

16. The method as recited in claim 9, wherein an act of performing the specified operation on each software related item in the plurality of referenced software related items comprises an act of partitioning each software related item in the plurality of referenced software related items to effectuate partitioning the software unit

17. The method as recited in claim 9, wherein an act of performing the specified operation on each software related item in the plurality of referenced software related items comprises an act of performing the specified operation on metadata describing one or more of the structure of software components, the behavior of software components, and other characteristics useful for organization and control of software components.

18. The method as recited in claim 9, wherein an act of performing the specified operation on each software related item in the plurality of referenced software related items comprises an act of performing the specified operation on metadata corresponding to a specific version of an application, framework, or service.

19. A computer system, comprising:
one or more processors;
system memory; and
one or more physical recordable-type computer-readable media having stored thereon a data structure representing a container version mapping and a data structure representing a software repository;
the container version mapping including for each software unit:
a software unit field storing a deployable unit value that identifies the software unit, from among the plurality of software units; and
a container version ID field storing a container version identifier value, the container version identifier value used within the software repository to identify a repository container version mapped to the software unit identified by the software unit value stored in the software unit field; and
the software repository configured to store software related items for a plurality of software units, each software related item being associated with a software unit from among the plurality of software units, the software repository including a plurality of tables storing software related items by item type, each table including:
a plurality of rows of software related items corresponding to a specified item type, each row including
a software related item data field storing software related data; and
a container version ID field storing a container version ID value from a container version mapping for a software unit, the container version ID value designating that the software related data stored in the software related item data field corresponds to the repository container version that is mapped to the software unit.

20. The computer system as recited in claim 19, wherein the one or more physical recordable-type computer-readable media have stored thereon repository version security data represent rights for accessing repository container versions, the repository version security data including a user entry for a plurality of different user identifiers, entry including:
a container version ID field storing a container version identifier value, the container version identifier value used within the software repository to identify a repository container version for a software unit; and
a rights field storing rights data indicating the rights of a user to perform operations on software related item data stored in the repository container version identified by the container version ID field stored in the container version ID field of the repository version security data.
